(19) United States
(12) Patent Application Publication
(10) Pub. No.: US 2010/0235409 A1
(43) Pub. Date: Sep. 16, 2010

(54) SYSTEM AND METHOD FOR MANAGING DATA STORED IN A DATA NETWORK

(75) Inventors: Warren Roy, Vancouver (CA); Eric Parusel, Vancouver (CA); Fred Leitz, Vancouver (CA); Quy Nguyen, Vancouver (CA)

Correspondence Address: McCarthy Tetrault LLP, Box 48, Suite #4700 Toronto Dominion Bank Tower, TORONTO, ON, M5K 1E6, CA

(73) Assignee: Global Relay Communications Inc.

(21) Appl. No.: 12/401,303

(22) Filed: Mar. 10, 2009

(51) Int. Cl. G06F 12/00; G06F 12/02; G06F 12/16

(52) U.S. Cl. 707/812; 707/E17.01; 707/E17.032; 707/E17.044

(57) ABSTRACT

The disclosure relates to a method and a system of data storage servers for processing an electronic file. The system has a set of servers in a network. The system further comprises a configuration file that contains data to specify the range of numbers in the set of file numbers assigned to servers in the network; a range table that contains data to track the range of numbers for the servers; and an application to process a request to store the file in the system. The application processes the request by: identifying a server that has a range of numbers that contains a file number associated with the file; and initiating storage of the file at the server. In the system, the file number is meant to be a unique number for files in the network.

### FIELD OF DISCLOSURE

The invention described herein relates to a system and method for managing files in a network of file servers.

### BACKGROUND

One prior art distributed database system is the Google File System (GFS)™. In the GFS, files intended for storage are disassembled into fixed-sized blocks, each block is distributed across a cluster of servers and the blocks are subsequently copied for fault tolerance. A centralized controller, which has access to the state of each server, coordinates distribution of blocks among the servers. One deficiency of the GFS is that the disassembled files must be reassembled upon retrieval. Reassembling files incurs network latency overhead from transferring blocks of data from distributed locations, onto a single location for further processing. Also, having a centralized controller leaves the GFS vulnerable if the centralized controller fails. While this is mitigated with redundant centralized controllers, having idle machines on stand by is not efficient hardware utilization.

There is a need for a system and method which addresses deficiencies in the prior art.

### SUMMARY

In a first aspect, a method of processing an electronic file in a network of data storage servers is provided. Upon receiving a request to store the file in the network, the method comprises: generating a file number to be associated with the file from a set of file numbers; associating the file number with the file; and for each server in the network, identifying a range of numbers in the set of file numbers that each server is responsible for processing, identifying a target server in the network associated with the file number, and sending the file to the target server for that target server to store in its memory.

In the method, the file number may be meant to be a unique number for files in the network and may be generated using a random number file generator.

In the method, the set of file numbers may be at least 2⁶⁴ in size.

In the method, if the file number has already been assigned to another file, another file number for the file may be generated from the set of file numbers.

The method may further comprise the following when a server in the network reaches a file capacity limit: identifying a second server in the network; copying files stored at the server to the second server; dividing the range of numbers into a first range of numbers that the server tracks and a second range that the second server tracks; deleting from the server files associated with the second range; and deleting from the second server files associated with the first range. The second server may be a backup server.

The method may further comprise maintaining for the server a configuration file that specifies the range of numbers in the set of file numbers assigned to the server.

The method may further comprise maintaining a range table to track the range of numbers for all servers in a cluster associated with the server in the network.

The method may further comprise reconciling contents of the range table with data provided from other servers in the cluster associated with the server in the network.

The method may further comprise: having the target storage server with a first cluster of servers in the network; having a second set of data storage servers in the network in a second cluster to also store files; maintaining for the network a cluster table that tracks network locations of the first and second set of data storage servers; and copying the files from the target storage server to a second server in the second set of data storage servers.

The method may further comprise: associating a flag indicating a copy notification parameter with the file number and the file; and generating a copy notification signal when the file has been copied to a preset number of clusters.

In the method, the copy notification signal may be generated when the file is copied to a server in another cluster.

Upon receiving a request from a client in the network to retrieve a stored file, the method may further comprise: identifying an assigned file number associated with the stored file from the set of file numbers; identifying the target server in the network associated with the file number; and initiating a request to the target server to retrieve and send the stored file to the client.

In the method, the request to store the file may be generated from a client to the network.

In another aspect, a system of data storage servers for processing an electronic file is provided. The system comprises a set of servers in a network for storing an electronic file. The set of servers comprises: a first server associated with a range of file numbers in a set of file numbers; and a subset within the set of servers associated with a remaining range of file numbers in the set of file numbers. The system further comprises a configuration file that contains data to specify the range of numbers in the set of file numbers assigned to the first server; a range table that contains data to track the range of numbers for all servers in the set of servers; and a first application to process a request to store the file in the system. The first application processes the request by: identifying a server in the set that has a range of file numbers that contains a file number associated with the file; and initiating storage of the file at that server in the set. In the system, the file number is meant to be a unique number for files in the network.

The system may further comprise a second application to process a request to retrieve a stored file from a client in the network. The second application may processes the request to retrieve the file by: identifying an assigned file number associated with the stored file from the set of file numbers; identifying a target server in the network associated with the file number; and initiating a request to the target server to retrieve the stored file.

The system may further comprise a client application in communication with the network to initiate the request to retrieve the file and to receive the file from the network.

In the system, the client application may operate on a computer in communication with the network and the client application may maintain a list of files that the client has processed through the network.

In the system, the client application may initiate a call to a third application to generate the file number for the request to store the file in the network.

The system may further comprise a fourth application to balance an allocation of files when a server in the network reaches a file capacity limit. The fourth application may initiate instructions to: copy files stored at the server to a second server; divide the range of numbers into a first range of numbers that the server tracks and a second range that the second server tracks; delete from the server files associated with the second range; and delete from the second server files associated with first range. The second server may be a backup server.

The system may incorporate features of the methods described above.

In other aspects, various combinations of sets and subsets of the above aspects are provided.

### BRIEF DESCRIPTION OF THE DRAWINGS

Embodiments of the invention will now be described, by way of example only, with reference to the accompanying drawings, in which:

FIG. 1 is a schematic diagram of a system having a network of clusters of servers for storing and distributing files accessed by clients communicating with the network as provided in an embodiment;

FIG. 2 is a schematic diagram of one cluster of servers in the network of FIG. 1 in communication with clients for an embodiment;

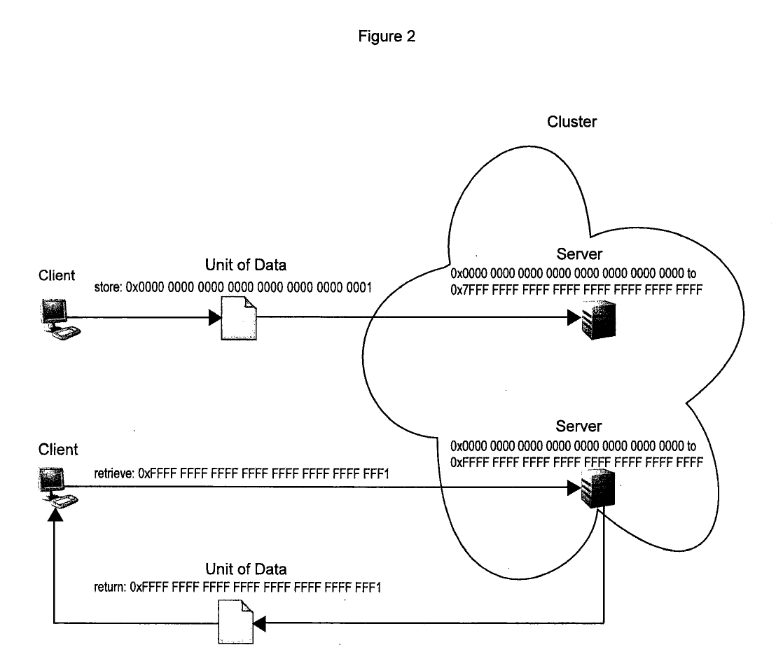

FIG. 3 is a block diagram of data being copied in an exemplary server in network 1 using a file copying algorithm of an embodiment in the cluster of FIG. 2;

FIG. 4a is a flow chart of a server locating algorithm of an embodiment for locating a server in a cluster of FIG. 2;

FIG. 4b is a flow chart of a write process in a file access algorithm of an embodiment to store data on a server in FIG. 2;

FIG. 4c is a flow chart of a read process in a file access algorithm to read data stored on a server of FIG. 2;

FIG. 5 is a flow chart of a file copying algorithm for copying data stored on a server to another server in a cluster of FIG. 2; and

FIG. 6 is a flow chart of a cluster copying algorithms for copying data between exemplary clusters in network 1.

### DETAILED DESCRIPTION OF AN EMBODIMENT

The description which follows and the embodiments described therein are provided by way of illustration of an example or examples of particular embodiments of the principles of the present disclosure. These examples are provided for the purposes of explanation and not limitation of those principles and of the invention. In the description which follows, like parts are marked throughout the specification and the drawings with the same respective reference numerals. In this description, occasionally subheadings are provided in italics. Such subheadings are provided as guideposts to the features described therein and are not meant to be limiting to the described features or other features in other subheadings unless noted.

### Overview

Exemplary details of embodiments are provided herein. Briefly an embodiment provides a method and system to store and retrieve data in a network. First, some detail is provided on architectural components of an exemplary network of an embodiment. Thereafter, further details on how embodiments store and retrieve data in the network are provided. Thereafter details are provided on other aspects of an embodiment.

At one abstract level, an embodiment provides a set of servers grouped in a logical cluster that is used to distribute and store all files for a system. A file identification scheme is provided to track the files among the servers. One scheme provides a set of identification numbers that define a universe of tracking numbers for files controlled by the cluster. Ranges within the set are assigned to different servers in the cluster. When a new file is to be stored in the cluster, an algorithm determines an identification number to be associated with the file from the range of identification numbers. Based on a mapping of identification numbers, a particular server in the cluster is identified as being the server to store the file. The file is then provided to that server. As a redundancy feature, a copying algorithm allows a server's files to be copied and distributed to another server on another cluster. Redundancy may be achieved with separate clusters.

The network may be configured to support multiple clusters. Each cluster can be configured to store all the data for the network and each cluster can be configured to backup its data with servers in another cluster. The clusters may be configured so that the servers in a cluster can communicate with other servers in other clusters without necessarily using a central control server (although such a server may be provided). Standby backup servers may be provided and may be configured and introduced into a cluster. Embodiments also provide algorithms that provide self-balancing of files among servers in a cluster. They also may facilitate scalability of the servers and the clusters and may provide fault tolerance.

### Exemplary Overall Network Architecture

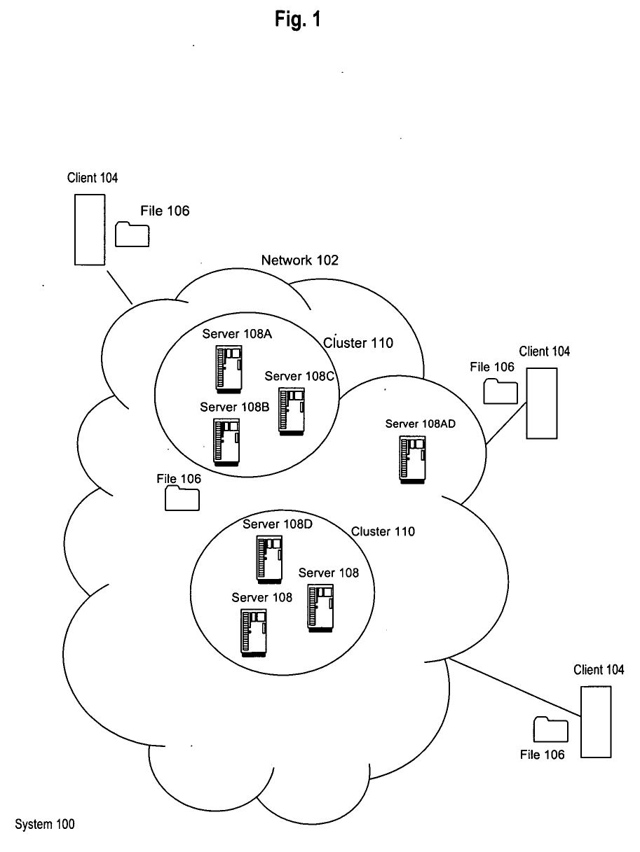

With a general overview of features of an embodiment described, further details on an exemplary network and its connected clients are provided. FIG. 1 shows system 100 where network 102 communicates with a set of clients 104. Network 102 stores files 106 for access by clients 104 in servers 108. An exemplary process for storing files in network 102 is provided using a file identifier tagging algorithm, where a file that is being stored is provided with a destination for storage in network 102.

Exemplary client 104 is a computer-based device having a microprocessor (not shown), a display (not shown), one or more storage devices (not shown) and communication connection to network 102. Client 104 may be a personal computer, a laptop computer, a mainframe computer, a cellular telephone or another device having such computer-based components. Client 104 may communicate with network 102 through an internet connection, a wireless internet connection, a Wi-Fi connection, an Ethernet connection or any other connection protocol or system known to a person of skill in the art.

A client 104 connected to network 102 may send a file that it has control over (for example by storage of the file in its memory) to network 102 for storage. A client 104 that is connected to network 102 may submit a request to network 102 for retrieval of a file 106 from network 102. Storage and retrieval of a file may be subject to access privileges and/or restrictions imposed on client 104 and or file 106. For an exemplary client 104, privileges and restrictions may be based on an associated user, location, time, size of file, type of file, associated application and other parameters.

For an embodiment, client 104 is a service that uses an application program interface (API) that provides routines allowing client 104 to communicate with servers 108 on the behalf of an end user application. It is not necessarily an end user application operating on a computer, such as a web browser. In one embodiment, client 104 may be provided as a web application, that is outside of the cluster 110, but inside of the network 102. Users of computers may be provided access to client 104 through a web browser. The web application may use an API that provides routines to store and retrieve files to and from servers 108. As such, client 104 may be associated with a variety of communication devices and platforms, such as networked computers and mobile communication devices. Client 104 uses an API to provide access to a cluster 110 and elements within the cluster 110. Interface routines between the API and external elements that it communicates with can be implemented in software and/or firmware routines following communication protocols known to those of skill in the art.

Network 102 provides a data storage and access system for files 106 on one or more elements in network 102, through (data) servers 108. Server 108 may be a computer-based device having a microprocessor, a display (or not), one or more storage devices (such as hard drives, tape drives, optical disks and electronic memory) and communication connection to network 102. Control of server 108 may be administered via a remote access link.

A network architecture for connection and communication protocols for servers 108 can follow architectures known to persons of skill in the art. An Internet Protocol (IP) addressing scheme may be used. For one embodiment servers 108 are grouped into clusters 110. In an embodiment, a cluster 110 stores all files for a system following the set of file numbers defined for the system. This assignment is provided at the time of deployment of a cluster. Each cluster is preferably provided with a unique cluster identification number. Each server 108 in a cluster is provided with a unique service identification number.

Servers 108 within a cluster communicate with each other through communication links (not shown). Servers 108 in one cluster 110 can communicate with servers 108 in another cluster 110 through one or more external communication links. Communication links are generally wired, dedicated connections, but may be wireless. Servers 108 may be deployed on a heterogeneous computer network; one embodiment utilizes an Ethernet network to allow components in the network to communicate with each other through known protocols.

Files may be transferred among elements in a network (e.g. from a client 104 to server 108 or from a server 108 to another server 108). In one embodiment, a file transfer protocol on top of transmission control protocol (TCP) interface may be used, such as FTP or HTTP. Other transfer interfaces may be used. Elements in a network may be located on the same network subnet and may communicate through broadcast, multicast or unicast messages to other elements or subnetworks.

Communications among devices in the network may be through messages, such as unicast or broadcast messages. In an Internet Protocol (IP) network, one or more servers 108 may communicate using a UDP broadcast message to servers 108 within a cluster residing on the same subnet (i.e. are connected to the same gateway) or a UDP multicast if the servers 108 within a cluster span multiple subnets. Payload of a broadcast may be an array of bytes representing the server 108 identification number (ID) and the file number range of the server.

There may be an administrative server 108AD that is in communication with one or more servers 108 and manages administrative tasks for network 102. A cluster 110 may also have an administrative server 108 to provide local administrative functions to its servers 108.

With some basic storage and retrieval components of an embodiment described, further detail is provided on aspects of a file distribution algorithm for files in cluster 110.

### Files and File Storage

Files 106 may be created or modified from applications operating on client 104 or may be downloaded to it from network 102. Files 106 may be an application data file, such as a Microsoft Word™ file, an Adobe “pdf”™ file, binary data, a digitized audio file, a digitized picture file, a digitized movie clip or any other data that can be stored and transmitted in a binary data form. In one example, a local Word document may be generated on a computer connected to network 102 and the Word document may be submitted to network 102 for storage through client 104. Also, client 104 may be used to retrieve a file from network 102 that may be subsequently used by Word at the computer.

One file storage algorithm used by an embodiment to stores files is a write-once, read-many implementation. Therein, the original author submits the file for storage to the network and then no further updates are permitted to the file. In such an architecture a file is not updated, per se. An update to a file may be provided by retrieving the file, amending it, deleting the original file from the system, and then storing the new file, which will have a new file identification number. It will be appreciated that other variations may allow modifications to be made by some parties and there may or may not be a time limit imposed where modifications may be made.

Each file stored in the network needs to be identified to allow it to be tracked. One embodiment utilizes a range of numbers that is set to be larger than the projected number of files for a storage system. For example, if there are expected to be no more than 100 files stored in the network, then the range of file numbers for the cluster may be set to be in excess of 100. Such numbers may be 100, 101, 110, 150, 200, 300, 500, 1000, 10000, 1000000000 or any other number (or factor) above a preset or anticipated number of files to be stored for the cluster. In some circumstances, the number may be set to be at or lower than the expected number of files. In one embodiment, each sub range of the file numbers is allocated to a distinct part of the range, such that when the sub ranges are considered together, there is no gap among the ranges. In other embodiments, one or more of the ranges may overlap between adjacent clusters. Exemplary ranges of values (expressed in terms of a power of 2, for convenience) are ranges of 2¹⁶, 2³², 2⁶⁴, 2¹²⁸, 2²⁵⁶, etc. Other base numbers and exponents may be used, if convenient. For one embodiment, the range of files is set to be, 2¹²⁸, thereby providing a range of file numbers between (in hexadecimal):
0x 0000 0000 0000 0000 0000 0000 0000 0000 and
0x FFFF FFFF FFFF FFFF FFFF FFFF FFFF FFFF.
   For this implementation, the number of potential files vastly outnumbers the number of expected files for the system. The number of potential files may be several orders of magnitude larger than the expected number of files (e.g. at least 3 or more orders of magnitude larger). It will be appreciated that other ranges may be used.

Once a file numbering scheme is set, servers 108 may be assigned different parts of the range of the file numbers. A server 108 is a single storage device (or logical set of storage devices) that is assigned to store units of data having a file number that falls within a specific range of numbers within the file list. Each set of file numbers may be equally distributed among the servers, but not necessarily. The set of file numbers may be contiguous or it may have one or more gaps therein. The distribution may account for the smallest, average, maximum or another characteristic of the server 108 (e.g. response time, redundancy level for one or more servers 108 and any other relevant factors for the performance of a server 108 or group of servers 108 in regards to its/their storage capacity and/or their retrieval issues).

Initial values and assignments for file ranges may be manually set by a system administrator. Alternatively or additionally, an algorithm may be provided to selectively parse the range of file numbers for a given number of servers 108 and then selectively assign a range of the file numbers to each of the servers. In some embodiments, one or more ranges may be not assigned. Additionally or alternatively, one or more servers 108 may have multiple ranges (or parts of ranges).

### File Number Generation

When a file 106 is to be stored in the cluster 110, an algorithm creates and identifies a new identification number for the file from the range of identification numbers. The identification number is then associated with the file for its storage and retrieval. Based on a mapping of identification numbers, a server 108 associated with that file number becomes the server 108 that stores the file. The file is then provided to that server 108.

One exemplary process used in an embodiment to generate a file number is as follows. First, client 104 makes a call to a subroutine from an API to generate the file number. In one embodiment, the file number is generated from a routine that provides a call to create an identifier based on a Version 4 Universally Unique Identifier (UUID) number generator, which provides a 128-bit number and may be presumed to be unique, based on general constructs on the UUID. A subroutine that generates the file number may not require any inputs nor any coordination with a (remote) central file-number generator. In one embodiment, client 104 can generate file numbers without associating them to files as the process to create file numbers simply consists of generating random numbers from an astronomically large number range, which is independent of associating that number with a file. Another embodiment may use contents and metadata of files as input to a hashing function to generate a sufficiently unique file number.

In an embodiment, file numbers are generated locally without using a central file number generator; each individual client 104 may use the same API (locally installed) to generate a file number. In one embodiment, as the file numbers are set to be very large, no coordination is provided among the client 104 when generating their local file numbers.

After the file number is generated, this unique file number may be associated with the file to be stored. A subroutine in the API may be provided to client 104 to associate the file number with the file and to send the file, file number and an optional notification flag to server 108. What the client 104 then does with the file number may vary across embodiments. For example, if client 104 is a web application that stores and retrieves files on behalf of an end user connecting via a web browser, then in one embodiment, after successfully storing the file and file number to a server, client 104 may return the file number to the web browser for the end user. In this embodiment, the history of file numbers and file lists would not be stored and subsequently tracked by client 104; instead, the end user would be responsible for tracking and storing the file number. In another embodiment, client 104 can store file numbers on behalf of the end user, via data and file maps relating to the generated file numbers and associated files, persisted in a table, such as a local, client-side file table. In this embodiment, client 104 may provide a user interface through which the end user may browse the files and file numbers previously stored by that end user.

### Server Configuration

In order to track files and file ranges by servers, clusters and clients, a set of configuration files are created, populated, maintained and accessed by elements in the network 102. Information is tracked for each server 108 and each cluster 110.

For each server, a Server Configuration File (SCF) is provided. The SCF specifies the file number range for the server 108 on which that SCF resides. The SCF outlines sets of properties for configuring the file number range of the server, capacity limit of the server, and scaling capacities of that server.

Data for a SCF may be updated by a server management application operating on the server. Initial values and assignments for file ranges listed in the SCF may be manually set by a system administrator or through an application. Periodically, server 108 may broadcast its range data to all other servers 108 in its cluster.

A server may also maintain a range table to track file number ranges for all servers in the local cluster. The range table may be an in-memory construct in server 108. When a server 108 initially starts up, it may load its file number range, along with other settings, from the SCF into memory. Some time after start up, server 108, may broadcast its file number range to other servers 108 and receive broadcasts from the other servers in the cluster providing their corresponding file number range. As a server 108 receives the file number ranges from other servers 108, it may build/update its local range table. As such, when a server 108 receives a broadcasted range data from a neighbouring server, it may revise or reconcile the received data range with its own range table.

One implementation of the SCF is a machine readable file that stores data in a plain text format (e.g. an ASCII file), where the SCF comprises a set of key/value pairs in separate lines. For example, one line of the SCF may contain the following data: serverId=Server1, capacityLimit=60%, fileNumberRange=0x0000-0xFFFF. Referring to Table A below, one data line for an exemplary SCF is shown:

TABLE A

| Field | Value | Notes |
|---|---|---|
| id | server1 | IBM server |
| capacity | 60.00% | |
| fileNumberRange | 0x0000-0xFFFF | |
| updateInterval | 300 | The interval, in seconds, |
| | | between broadcasting the |
| | | server's file number range. |
| clusterTableLocation | 10.9.45.1 | The IP address of the DNS |
| | | server 108 that stores the |
| | | cluster table. |

The Notes field may be part of a text file stored in the Table and is generally not provided as data in communications among servers.

During a network startup routine, a server management application for a server may access the server's SCF, then retrieve its file number range from the SCF and load that file number range into its memory. Thereafter, server 108 may broadcast its file range to the other servers 108 in its cluster 110. As such, in a startup routine, all servers in a cluster may have operating information on their neighbours.

In addition to tracking data relating to a server, additional data is provided for a cluster in a network. For clusters, a Cluster Table (CT) is created and managed which contains data of addressing information for clusters 110 and the location of servers 108 within each cluster 110. In an embodiment, a CT provides a directory of clusters, indicating the IP addresses of the servers 108 within each cluster. Data received from other servers 108 (e.g. in a broadcast, unicast or multicast) may be used to update the cluster table. The CT may be updated directly as well.

The data in a CT is used in conjunction with the range table to reconcile data used in network 102. A server management application may use the data in the range table to check and reconcile data from other servers 108 in the cluster. A reconciliation of the data may arise if any of the following data irregularities are detected: overlapping ranges among servers, gaps in the data, missing responses from servers or other fault conditions. If an issue with the data is detected, then a message may be generated and sent to the affected servers. For example, an email may be generated to a predefined email address. Additionally or alternatively, a message may be sent directly to the affected servers.

In one embodiment the CT is stored in a DNS Server (which may be mirrored for fault tolerance). In operation, servers 108 load the IP addresses of the DNS Server from the SCF and issue DNS requests to that DNS Server to discover the IP addresses of every server 108 in every cluster 110. Each server 108 may store this retrieved information in its local memory. The data in the CT is generally static and would benefit from updates only upon certain change events, such as a network topology change (including addition or removal of servers from a cluster).

Referring to Table B below, an exemplary CT is shown:

TABLE B

| | | |
|---|---|---|
| Field | Value | Notes |

| | |
|---|---|
| ClusterA-Server1-IP: | 10.21.9.1 |
| ClusterA-Server1-Location: | Vancouver |
| ClusterA-Server2-IP: | 10.21.9.2 |
| ClusterA-Server2-Location: | Vancouver |
| ClusterB-Server1-IP: | 10.21.10.1 |
| ClusterB-Server1-Location: | Toronto |
| ClusterB-Server2-IP: | 10.21.10.2 |
| ClusterB-Server2-Location | Toronto |

The Notes field may be part of a text file stored in the Table and is generally not provided as data in communications among servers.

Servers in a cluster 110 may communicate with each other via UDP broadcasts when they are located on the same network subnet. Servers 110 spanning multiple subnets may communicate via UDP multicasts. It will be appreciated that a cluster 110 may have an internal multicast address and its server 108 can be configured to listen to that multicast address to receive communications from that address. Then, an external message received at that address may be distributed to the servers in the cluster.

As servers 108 receive the file number ranges from other servers, they may build a range table that maps each server 108 identification number to each file number range. The servers 108 may then keep their range tables current by periodically rebroadcasting their file number ranges. The amount of time each server 108 waits between broadcasts may be governed by an update interval value, configured in the SCF. File number ranges may be sent and received via UDP multicast/broadcast. Clients 104 and servers 108 make DNS request to a DNS server for CT data. Clients 104 and servers 108 may obtain range tables by a unicast application-level protocol running on top of a TCP connection, which therein includes a TCP handshake.

In order for client 104 to store and retrieve a file from a cluster, it needs to identify a file number for that file from the range of file numbers. It also needs data from the range table stored in servers.

To obtain routing information, client 104 requests or receives data from a range table from one of the servers 108 in cluster 110. Exemplary data mining operations between client 104 and the servers 108 are as follows. When client 104 needs to identify and request a range table, it may first check its local memory for same. If it is not present or if it has a stale dated timestamp, client 104 may generate and send a message to any server 108 to request data relating to a range table, as each server 108 would have a local copy of the range table for the cluster. When client 104 needs to identify and request a routing server, client 104 consults the CT. As the cluster table contains the IP addresses of servers, client 104 may analyze the addresses to identify a server 108 that is most suitable to client 104. For example, the closest server 108 may be selected by comparing its IP address to the IP address of client 104. Additionally or alternatively other factors, such as connection bandwidth, redundancies or other factors may be provided as part of the selection algorithm. Once a server 108 is selected, client 104 may then initiate a TCP connection to the IP address of the selected server 108, issuing a request for the range table. Once the contacted server 108 receives the request, server 108 may then extract from its local memory its range table and transmit the relevant data as a sequence of bytes to client 104. It will be appreciated that in one embodiment, all servers 108 within a same cluster 110 will have the same range table data, as they broadcast their the file number ranges to one another through the protocol described earlier.

Once the table is received, a new file number in the range of numbers can be generated and assigned to the file. Referring to Table C below, an exemplary range table is shown:

TABLE C

| | | |
|---|---|---|
| Field | Range | Notes |

| | |
|---|---|
| Cluster A: Server 1 | 0000-1023 |
| Cluster A: Server 2 | 1024-2048 |
| Cluster A: Server 3 | spare |
| Cluster A: Server 4 | spare |

The Notes field may be part of a text file stored in Table C and is generally not provided as data in communications among servers. It will be appreciated that other tables may store other data.

In one embodiment, the file number generator is a pseudo-random number generator that is based on the size of the file number base. In such a system, the probability of the returned number being already used is low. However a check for the prior use of the number can be performed and if the returned number matches an existing file number for a file, then another number may be generated. In another embodiment, a hashing function may be used to generate the number. Use of a hashing function may require that the entire contents and metadata of each file are accessed and processed, in order to create a sufficiently unique identifier from the hashing function.

Once a file number has been created, the file is associated with the file number. Next, using a mapping of file numbers to servers 108 in a cluster, server 108 that is assigned a range of numbers that contains the file number gets carriage of the file. The embodiment may provide a series of consistency and contingency checks on the data. For example, if an error message is provided that the storage is not successful, then server 108 may return an error code to the client 104. Also it will be appreciated that the embodiment may tolerate different sized data to be stored, as a “unit of data” is not restricted to a fixed size of data, as the term in one embodiment simply refers to a file which has been identified with a file number. If a file to be stored exceeds any limits on file size, due for example to a lack of capacity at server 108, then the target server 108 can identify this situation and generate and send an error code back to client 104. If the destination server 108 successfully stores the file, it will return a success code to the client.

At this time, a file table on server 108 is updated, where the file number is associated with the location in the file system of the server where the file was stored. If an error occurred, the server 108 will generate and send an error message with an error code to the client.

Queries may be provided to the network based on the file numbers. A client 104 may determine if a particular file number is used by querying server 108 responsible for the range in which that number falls; that server 108 will perform a binary search across its set of files and answer whether or not that file number is in use. Further detail on queries provided to the network is provided below.

With elements of the architecture and data for a network described, further detail is provided on read and write procedures for files processed by an embodiment. First a process is described illustrating how a client identifies a server for a read or write process, then a write process is described, followed by a read process.

### Server/Cluster Identification

An embodiment provides the following algorithm, which is implemented in a file retrieval routine of its API, which identifies and accesses a server 108 in network 102 from which to initiate a request to retrieve its target file. Therein, client 104 accesses a CT, stored in a remote DNS server, to discover the list of clusters 110 in the network 102 and the servers 108 within each cluster 110 as any cluster contains a complete snapshot of files for network 102. Client 104 selects a cluster 110, and then a server 108 within that cluster 110 from which to request a range table. The cluster may be selected through any suitable algorithm. One algorithm is to select the cluster that is geographically closest to client 104. This may be identified by examining the IP addresses of the clusters in the CT and comparing them against the IP address of the client 104. Other parameters, such as any bandwidth capacities associated with the clusters or other characteristics (size of cluster, age of cluster etc.) tracked in the CT may be used. The server may be selected through any algorithm. In one embodiment, the first server in the table associated with the selected cluster is used. Once the range table is retrieved, client 104 analyzes data from the range table and identifies a server in the cluster that is responsible for the file number range in which the file number for the file is located. As such, client 104 can then access the identified server to retrieve the requested file.

In one embodiment, data in the CT is preferably persistent and is remotely accessible and updatable by servers 108 across geographically scattered clusters.

One system for providing a look-up service for a cluster table is the Domain Name System (DNS), which provides a distributed and fault tolerant system for distributing data. As such, a cluster table is exposed as a DNS server, which stores the clusters and servers 108 within each cluster as Service Location (SRV) records. Table D below shows an exemplary SRV for a cluster.

TABLE D

#SRV Format: _Service._Protocol.Name TTL Class SRV Priority
Weight Port Target
#Example:
#Cluster List
_clusters._tcp.clustername.example.com. 86400 IN SRV
0 5 0 cluster1.clustername.example.com
_clusters._tcp.clustername.example.com. 86400 IN SRV
0 5 0 cluster2.clustername.example.com
#Server List For Cluster 1
_server._tcp.cluster1.clustername.example.com. 300 IN SRV
0 5 443 a.cluster1.clustername.example.com
_server._tcp.cluster1.clustername.example.com. 300 IN SRV
0 5 443 b.cluster1.clustername.example.com
#Server List for Cluster 2
_server._tcp.cluster2.clustername.example.com. 300 IN SRV
0 5 443 a.cluster2.clustername.example.com
_server._tcp.cluster2.clustername.example.com. 300 IN SRV
0 5 443 b.cluster2.clustername.example.com

Table D shows at the top, a format for an SRV Record and below, an example set of records detailing the locations of servers 108A and B, in clusters 1 and 2. Since DNS servers are designed to be distributed and copied, a mirrored DNS server can be deployed within each cluster, for load balancing. During start up, each server 108 can load the location of a DNS server from the SCF. Thereafter it can periodically issue queries to that DNS server to discover the list of clusters and the locations of their servers.

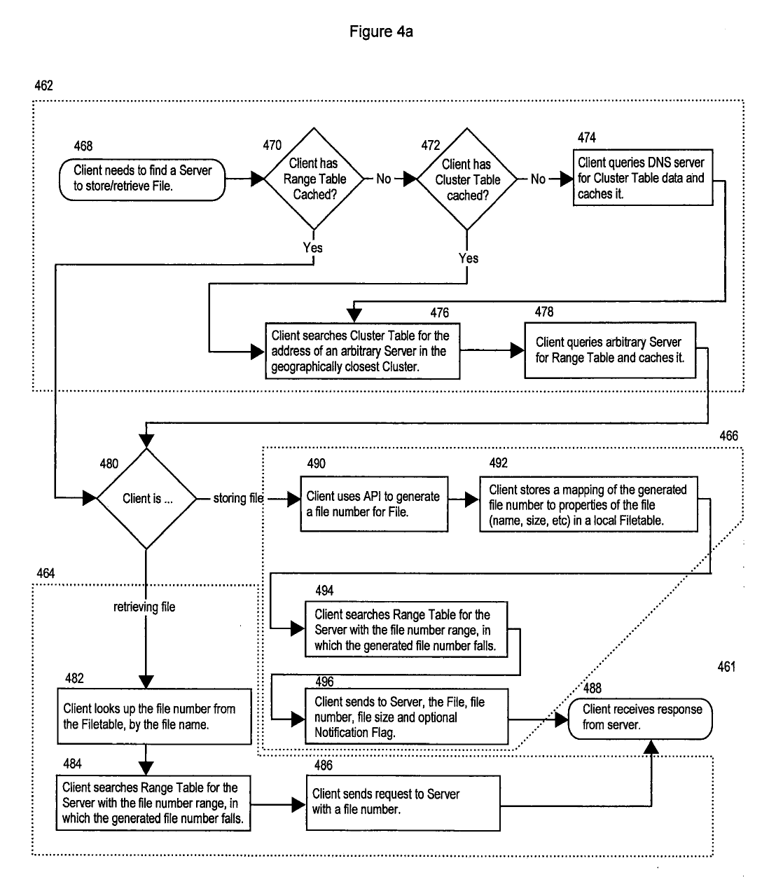

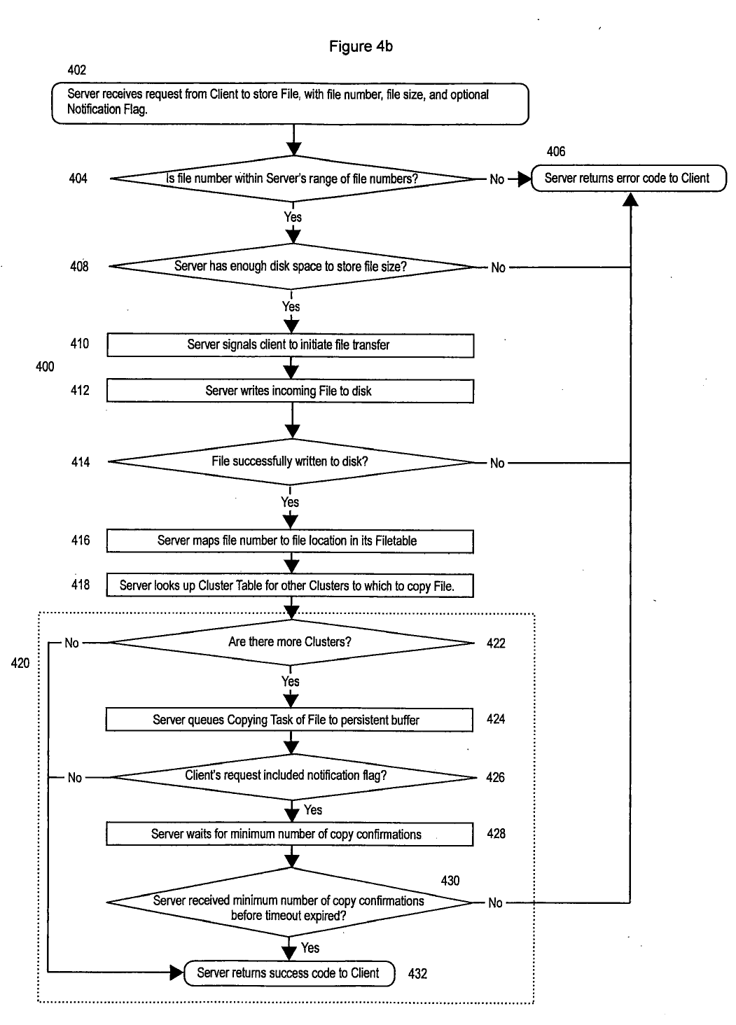

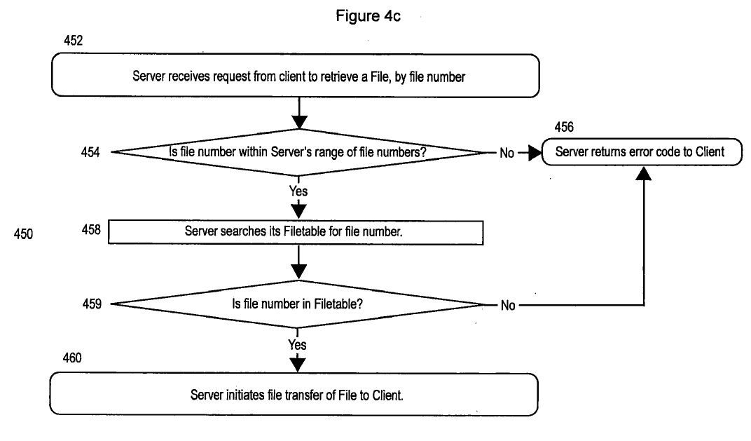

Now referring to FIG. 4a, further detail in flowchart 461 is presented on an algorithm used by client 104 to identify a server 108 in a cluster 110 for a read or write operation. There are three sections to flowchart 460. Each section is a grouping of processes that macroscopically provides one overall function. The sections are provided for the sake of convenience and do not necessarily need to include all of their cited processes. In section 462, client 104 determines file numbers from a cluster table that provides an indication of the servers that may be accessed for the relevant file. Section 464 describes processes relating to client 104 retrieving a file from a cluster. Section 466 describes processes relating to storing a file by client 104. Each process includes a series of recited steps. While the steps are executed in an order, as described, it will be apparent to those of skill in the art that in other embodiments, some steps may be executed in different orders or in parallel, while still providing the same functionalities as described herein. The order of execution also applies to the described section and other processes. Each section is discussed in turn.

Referring to section 462, first at step 468, client 104 determines that it needs to identify a server 108 from which to store and/or retrieve a file. Next at step 470, a test is made to determine whether the client 104 has cached the range table. If the range table is cached then the process proceeds to step 480 in which a determination is made as to whether client 104 is retrieving the file or storing the file. However, if a client has not cached the range table, then process 462 proceeds to step 472 where a test is made to determine if client 104 has cached the cluster table. If the cluster table has not been cached then at step 474 client 104 queries the domain name server for the cluster table data and caches it in its local memory.

Then client 104 at step 476 searches the cluster table for the address of a server 108 in the geographically closest cluster. The geographically closest cluster may be determined by any number of algorithms including an analysis of the IP addresses of the clusters in the table. Alternatively, any algorithm may be used to select the cluster. There may be additional parameters associated in the cluster table that provide selection parameters for the cluster. Such parameters include size of the clusters, age of the clusters, speed of the clusters etc. If at step 472 a cluster table has been cached then from that test the process proceeds directly to step 476.

After 476, at step 478 client 104 queries the arbitrary server for its range table and caches it. At this point, section 462 is complete.

Then at step 480, a test is made to determine whether client 104 is either retrieving the file or storing the file. If the client is retrieving the file then the process executes retrieving file functions noted in section 464.

In a read function, at step 482 client 104 examines the file table and accesses the file number from the file table using the filename. Then at step 484, client 104 searches the range table for the server 108 with the file number range where the file number lands. Then at step 486, client 104 requests server 108 for server 108 to send the file identified by the file number to client 104. Then at step 488, client 104 receives the response from server 108.

However, if returning back to step 480, if the client is storing the file then the following processes are provided in section 466. Therein, at step 490, client 104 uses an API to generate a file number from the file. Then at step 492, client 104 stores a mapping of the generated file number to properties of the file in a local file table. The properties may include the name of the file, the size of the file and other parameters. Then at step 494, client 104 searches the range table for the server identified with the file number range where the generated file number exists. Then at step 496, client 104 sends to the server the file, file number, file size and any notification flags. Thereafter, client 104 receives a response from server 108.

Further detail is now provided on the write and read operations, using the file numbers and cluster information identified in sections 466 and 464, respectively.

### Write Operation

Referring to FIG. 4b, a write operation for a file from client 104 to network 102 is shown generally in flowchart 400. Prior to execution of a write process, client 104 will have identified a file in its control that is to be stored in network 102 and a file number from the range of file numbers will have been generated for the file. A file tag containing the file number and any particulars for the file will also have been created and will have been associated with the file. Beginning at step 402 server 108 receives a request from client 104 to store a file. The file is associated with the tag providing a file number, file size and notification/status flags.

Next at step 404, a test is made to determine whether the file number is within the server 108's range of file numbers. If the file number is within the file range for that server then at step 408 a determination is made as to whether the server 108 has sufficient storage space (e.g. in its secondary hard drives) to store the file. If not, then at step 406, server 108 returns an error message to client 104.

After the secondary test, if server 108 does have sufficient storage space, then the write process proceeds to step 410 where server 108 generates and sends a message to client 104 to initiate the file transfer for the file. At that point client 104 receives the message and prepares and sends the file through the communication protocols of the network. Next, at step 412 server 108 receives the file and writes the file to its local storage space. Then at step 414, server 108 checks whether the file was successfully stored to its local storage space. If the file was not successfully received and stored then the process returns to step 406. If the file was successfully stored, then at step 416, server 108 maps the file number to the file location in its file table. Also, the new capacity of the server may be recorded at a convenient location.

With the file successfully stored, additional processes are provided to determine whether copies of the file need to be sent to other clusters. At step 418, server 108 accesses and checks the CT to determine whether any additional clusters should be provided the file. Each cluster in the CT should be provided with a copy of the file. To forward the file to the additional clusters, processes in section 420 are executed.

First, in section 420 a test is made to determine whether more clusters are to be forwarded the file at step 422. If there are not any more clusters then the process proceeds to an exit message at step 432. However, if there are more clusters then at step 424 server 108 queues a copying task of the file to a buffer in the server. Then at step 426, a test is made to determine if the flag associated with the file from the client included a notification indicator. If an indicator was provided, then at step 428 server 108 waits for a receipt of copy confirmations from other clusters. There may be a minimum number of confirmations that are preset to be received. If no confirmation was set then the process proceeds to the exit message at step 432.

The notification flag provides the following synchronization between client 104 and server 108 during writes to other clusters. As an example, consider where client 104 sends a file to server 108. Server 108 may successfully store and report its storage to client 104, but after scheduling a copying process, server 108 may have a fatal error prior to execution of the copying process. The file may be lost, unknown to the client. To address this possibility, when client 104 requests to store file to server 108, client 104 can issue to server 108 a copying notification flag. The flag indicates that server 108 needs to notify client 104 when it has received a minimum number of copying confirmations. If client 104 receives the notification, client 104 knows that the file has been copied the minimum times client 104 requested. If the notification is not received within a set timeout period, client 104 may assume server 108 has failed and can attempt to resend the file at a later time, when a spare has replaced that server. Referring to Table E below, an exemplary list of notifications is provided:

TABLE E

| Status | Value | Notes |
|---|---|---|
| File Storage Successful | 0 | |
| File Storage Failed | −1 | |
| Minimum Number Of Copying | −2 | |
| Confirmations Not Met | | |
| Filenumber not found | −3 | When server 108 receives |
| | | request to retrieve a filenumber |
| | | it does not have |
| Filenumber out of range | −4 | When server 108 receives |
| | | request for file number outside |
| | | its range |

Other notifications and status checks may be provided relating to the size, time, age, source or other parameters of the files. Client 104 may provide the values for flags, through optional parameters to the subroutines of the API.

Turning back to flowchart 400, after step 428, if a notification was set, then at step 430 a next test is performed to determine whether server 108 has received a minimum number of confirmations before a preset time out has expired. If the minimum has expired then the process exits section 420 and returns to step 406. If the minimum has not expired then server 108 returns a success code to client 104 at step 432 and the cluster update is complete.

An embodiment also provides a mechanism to check when a file stored at a server 108 in a given cluster 110 is actually stored at the correct server. It is possible that the selected server 108 may not be responsible for storing files for the file number range associated with the file. To determine the actual server that is responsible for the file number, server 108 makes a request for a range table from another server 108 in that cluster 110. The cluster and server may be identified from the CT. Once the target server provides its range table data, server 108 may determine a destination server in the cluster that is currently responsible for the range of file numbers for the file to be stored. The server 108 then queries the destination server, asking if the destination server 108 already has a copy of the file.

Each server 108 has a local file table that maps file numbers to locations of files on that server 108. A server 108 typically is only aware of the range of file numbers other servers 108 can store, but it may not be aware of what files other servers 108 actually store. Server 108 may, in any event, send a query to another server 108, which may be implemented in a subroutine in the API, that asks if the other server 108 stores a particular file.

### Read Operation

Turning now to a read operation for a file by a client, to retrieve (read) a file, client 104 accesses the file table to identify a file number from stored files in cluster 110. From the file table, it can identify the file number of the target file. If the target file is not found, then an error message is generated. If the target file is found, then the server 108 retrieves the file, using the file number as a reference point to obtain the file and provides it to client 104. At this point, client 104 may then relay the file back to an end user application, such as a web browser.

Herein, client 104 should have the file number of the file that it is retrieving. An embodiment may employ one or more of several processes that allow a client to determine a file number for a file. In one embodiment, a client may maintain a local file table that stores a mapping of file numbers to file properties (name, size, the person who submitted the file, and the date it was submitted, etc) of files previously stored in the cluster 110 by that client 104. It will be appreciated that this client-side file table is typically different from the server-side file table. The server-side file table maps file numbers to the location on the file system that file is stored on that server.

As an example, consider a word processing document that is to be centrally stored by an embodiment. The word processing software, such as Word™, is an end user application which, in a typical embodiment, would not interface with client 104 directly. The end user may create a document and save it locally on his computer. Using an embodiment, a web application is provided as an interface for centrally storing files. The end user accesses a web browser and visits the URL of the web application for the storage embodiment. Through the browser, the locally stored document may be provided to the web application. This web application would be the client 104 to the cluster 110. The client 104 would generate a file number for the document and may store the file number with the name of the file, the date the file was uploaded to the client, in a client-side file table.

An exemplary client-side file table is Table F:

TABLE F

| Filenumber | Filename | userId | . . . |
|---|---|---|---|
| 4215 | jsmith-resume.doc | jsmith@companyA.com | . . . |
| 2992 | system-backup.zip | kstevens@companyB.com | . . . |

This file table can be used as a means for the web application to recall for an end user or process the file numbers of files that end user has previously stored.

After client 104 stores the mapping in the file table, it will then determine from the range table the server 108 that is responsible for the file number range in which the generated file number falls. Then it will send to that server 108 a request to store the file.

Referring to FIG. 4c, a read operation for a file by client 104 from server 108 is provided at flowchart 450. Beginning at step 452, server 108 receives a request from client 104 to retrieve a file. The request includes the file number associated with the file. At step 454 server 108 checks the range table to determine whether the file number is within the server's range of file numbers. If the file number is not within the server's range of file numbers then the process proceeds to step 456 where server 108 returns an error code to client 104. If however the file number is within the server's range of file numbers then at step 458, server 108 searches its file table for the file number. Next at step 459, if the file number is in the file table then at step 460 server 108 initiates the file transfer to client 104. However, if the file number is not within the file table then the process returns an error per step 456, thereby completing the read operation.

### Delete Operation

Turning now to a delete operation for a file by a client, to delete a file, client 104 accesses the file table to identify a file number from stored files in cluster 110. From the file table, it can identify the file number of the target file. If the target file is not found, then an error message is generated. If the target file is found, then the server 108 deletes the file, using the file number as a reference point and the local records are updated. The local file list at the client may then be updated. Also, the new capacity of the server may be recorded at a convenient location, such as in the SCF.

### Caching Data

Enhancements may be provided for the read and write operations. For example, client 104 may cache a range table to reduce communication overhead of retrieving a table for every interaction with servers 108. In one embodiment, servers 108 are the final arbiter on the range of file numbers that they manage. If a server 108 rejects a request for a file because the requested file number is outside of its assigned file number range, this may be used to indicate that the client's range table is not current. At this point, the refusing server 108 may provide an updated range table to the client 104.

Copying Data within a Cluster

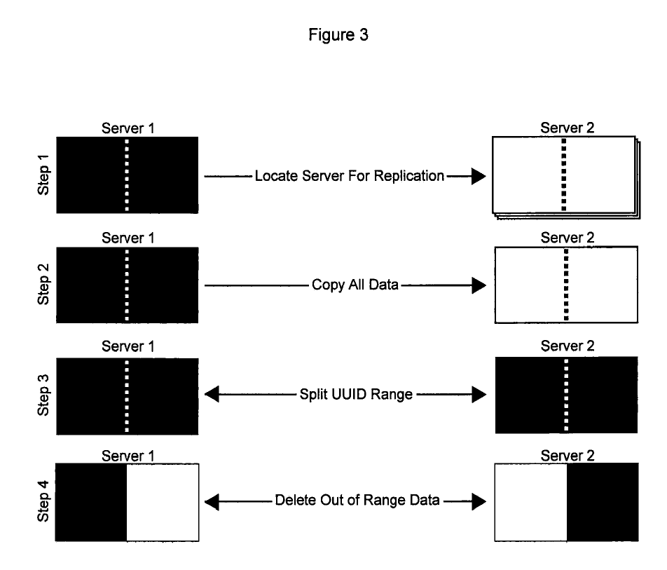

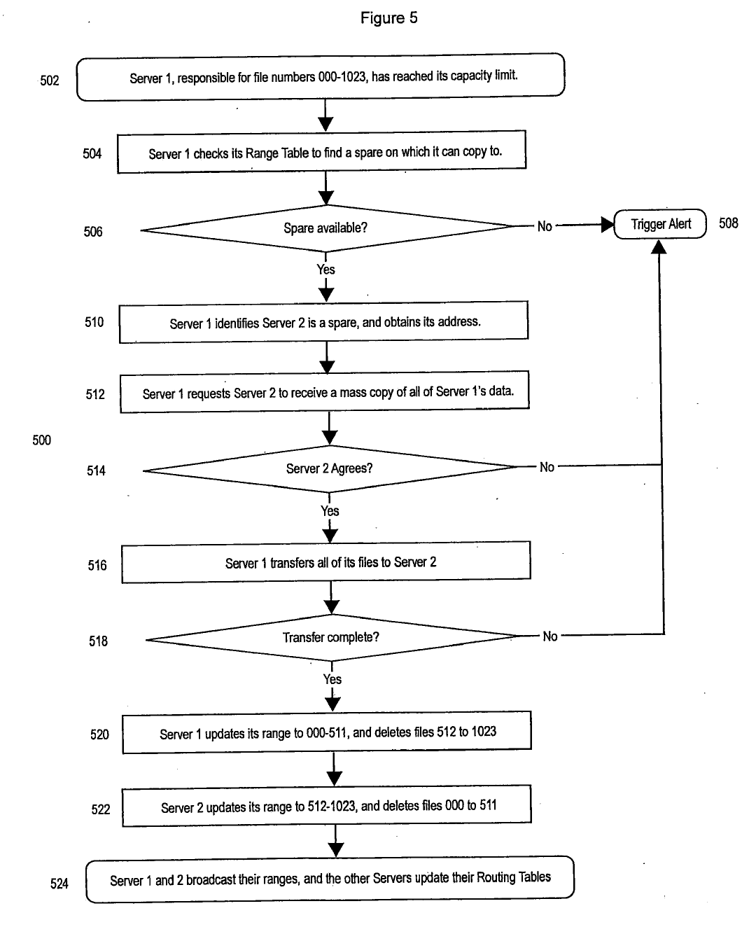

Referring to FIGS. 3 and 5, further detail is now provided on other features of an embodiment, including how files are copied inside a cluster, how clusters are copied, how failure or exception conditions are identified and processed and notification procedures.

For copying files within a cluster 110, an embodiment is provided with algorithms to self-balance loads among its servers 108 in a cluster 110. As previously noted, the file number is very large. As such, a cluster 110 will likely lack the storage capacity to store all files in the file number set at the current capacity secondary storage (hard disk drive) systems. One advantage of this relationship between the number of potential files for the identification system and the number of expected files for the system is that a server 108 will likely run out of physical storage space, well before exhausting its file number range. This relationship facilitates adding capacity to a cluster 110 and rebalancing the distribution of data.

Referring to FIG. 3, a series of four steps diagrammatically show how “Server 1” (for example server 108) addresses its storage capacity that is approaching its limit. In FIG. 3, a box represents the total storage capacity of given server. A black section in the box signifies a filled portion of the storage capacity and a white section signifies an unfilled portion. Generally, when a server 108 reaches its storage capacity limit or threshold, a pooling algorithm may be initiated. For the pooling algorithm, a set of server spares 108B-C may be provided as immediate spare servers for any online server 108. At step 1, the source server 108A (“Server 1”) is filled (or nearly filled) and the pooling algorithm selects a spare server 108B (using parameters such as age, size of server, type of storage capacity, compatibility with existing server, type of server, etc). At step 2, data stored in server 108A is copied onto the spare server 108B (“Server 2”) through file commands provided in the network. At step 3, copying of data is complete (as shown by the filled blocks for server 108A and 108B). Next, the file number range of server 108A is divided between server 108A and server 108B. In one embodiment, the split is evenly divided into contiguous blocks. In other embodiments, the split may not be even and may not be in contiguous blocks. At step 4, once server 108A and 108B both have their file numbers reassigned, servers 108A and 108B then purge from their local storage the files that have file numbers that are outside their newly assigned range. In the embodiment, server 108A retains the first half of files and deletes the second half of its files and server 108B retains the second half of its files and deletes its first half of files. This creates additional storage capacity for cluster 110 while maintaining a balanced distribution of data. It will be appreciated that a distribution may be provided among N servers 108 at any given time. It will be appreciated that some of the steps described herein may be performed in a different order than presented, as long as data integrity is maintained.

Referring to FIG. 5, flowchart 500 provides further details on a server copying algorithm when server 108 has reached its capacity limit. To begin, at step 502, a server is noted to have reached its capacity limit. For example, in a configuration where it is assigned a block of file numbers 0-1023, all file numbers in its assigned range have been filled. (It will be appreciated that there may be a threshold for noting a server as being filled.) Then at step 504, server 108 checks its range table to find a spare on which it can copy. Then at step 506, within the cluster, a test is made to see whether a spare server is available. If no such spare server is available, then the process proceeds to step 508 where an alert is triggered and the process ends. However, if a spare is available then at step 510, the original server 108A (“Server 1”) identifies another (second) server 108B (“Server 2”) as its spare and obtains the address of the second server. At step 512 server 108A requests server 108B to receive a complete copy of all of the files in server 108A. Then at step 514, a handshake check is performed with server 108B to determine if it agrees and confirms that it can receive all of the files. If server 108B cannot receive all of the data then an alert is triggered at step 506. If server 108B can receive all of the data then server 108A transfers all of its files to server 108B at step 516. Next a test is performed at step 518, to determine if the transfer is complete. If the transfer is not complete, then the process will trigger an alert at step 506. However, if the transfer is complete then at step 520 server 108A updates its range table and SCF to the new range values and deletes either the upper or lower file range from its server. Next, at step 522 server 108B updates its range table and SCF to recite the complementary range that has been deleted from the first server. Finally, at step 524 server 108A and 108B broadcast their ranges to other servers in the cluster, which locally initiates updates to their range tables.

The copying process may maintain a record of activities during the copying process. If an error is detected during the copying process, then the copying and deleting processes may be rolled back according to the record. If the first server is still operational, then the second server may be removed from service and another backup server may be loaded with a mirror of the files from the first server. Additionally or alternatively, the second server may be re-classified as being the first server if the fault occurs in the first server and the second server has a full copy of the files from the first server.

Servers 108 in a cluster do not need to have the same capacity and speed. As such, each server 108 may be configured with a capacity limit in the SCF, which may be expressed as a percentage of the total capacity that server 108 can store and process data. When a capacity limit is reached, a spare server 108 may be deployed into the cluster. It will be appreciated that various factors and operating parameters may be used to determine a capacity limit for a server 108 in a given operating environment.

The capacity of the servers 108 in cluster 110 is periodically monitored. This may be checked when each server 108 broadcasts its capacity to other servers. Alternatively, one or more servers 108 may request capacity information from its peers.

In one embodiment, if servers 108 in a cluster 110 are configured with equal-sized file number ranges and clients 104 generate file numbers randomly, then as clients 104 store files to cluster 110, servers 108 within the cluster may be filled at approximately same fill rates. Consequently, the servers may trigger for rebalancing at approximately the same time. An embodiment may avoid this scenario by having servers 108 configured with staggered capacity limits, so that servers 108 in a cluster reach their capacity limits at different times and rebalance at different times. Alternatively, servers 108 may be configured with unequal-sized file number ranges. Servers 108 would then fill at different rates (relative to their capacities) and rebalance at different times.

Copying Data between Clusters

Cluster copying provides redundancy for a data set of files, which is not provided in a single cluster system. In a single cluster system, servers can employ mirrored hard disks to mitigate data loss and corruption, but this will not protect them from hardware failures, power outages, and network failures. An embodiment provides fault tolerance through additional geographically dispersed clusters.

In an embodiment, each cluster 110 in the network 102 provides copies of files to other clusters 110. This may be achieved through cross-cluster copying, where each server 108 in a cluster relays files it receives from clients 104 to other clusters 110 in the network 102. The cluster may relay the files to all the clusters. As such, every cluster 110 can be copies of each another. When copying files from clusters 110, servers 108 in a cluster may copy files to servers 108 in other clusters 110 that are associated with the matching file number range of the originating servers. For example, referring to FIG. 1 a file stored in server 108A in a first cluster 110 may be copied to server 108D in another cluster 110.

When a server 108 successfully stores a file received from a client 104, the server queues a copying task to a persistent buffer. The copying task and persistent buffer are used in a process to relay that file to servers 108 in another other cluster 110. Preferably, the target servers in the other clusters are associated with the matching file number range of the originating server. Again, the copy task may be queued for all clusters. The copying task includes the file number of the file to copy and the set of cluster identification numbers of clusters that have returned copying confirmations. This set is initially nil. The persistent buffer may be implemented with a relational database or persistent messaging queue. Each server 108 may have its own persistent buffer. Alternatively or additionally there may be a central buffer.

As noted earlier, each server 108 has a local file table that maps file numbers to locations of files on that server 108. A server 108 typically is aware of only the range of file numbers other servers 108 can store. It may not be aware of what files other servers 108 actually store. Server 108 may, in any event, send a query to another server 108, which may be implemented in a subroutine in the API, that asks if the other server 108 stores a particular file. The queried server 108 will then search its local file table for the requested file and respond to the querying server 108. The response can indicate whether or not it has the requested file.

Servers 108 periodically poll copying tasks from their persistent buffers. From the retrieved tasks, the servers can determine a file that is flagged for copying and the clusters 110 that need to be updated with a copy of that file. For each cluster 110, the server 108 may obtain a range table (if it is not already cached) from any server 108 in that cluster 110, and from that table it can determine an appropriate destination server 108 on which to copy the file. Server 108 then queries the destination server 108, asking if the destination server 108 already has a copy the file. If so, the destination server 108 returns a copying confirmation message to the initial server 108. Then the initial server 108 updates its copying task and proceeds to attempt to copy the file to the next cluster. If not, initial server 108 sends a copy of the file to the destination server. If the destination server 108 successfully stores that copy, it will return a copying confirmation to the initial server 108. Then the initial server 108 updates its copying task and attempts to copy the file to another cluster. In one embodiment, the destination server 108 may then repeat the process of requesting to send the copy to every other cluster. As such, eventually each cluster in the system will have a copy of the file that originated from the client. It will be seen that in this process, the copy of the file among clusters is performed without coordination from a centralized controller.

Further details are now provided on aspects of copying of files among clusters 110.

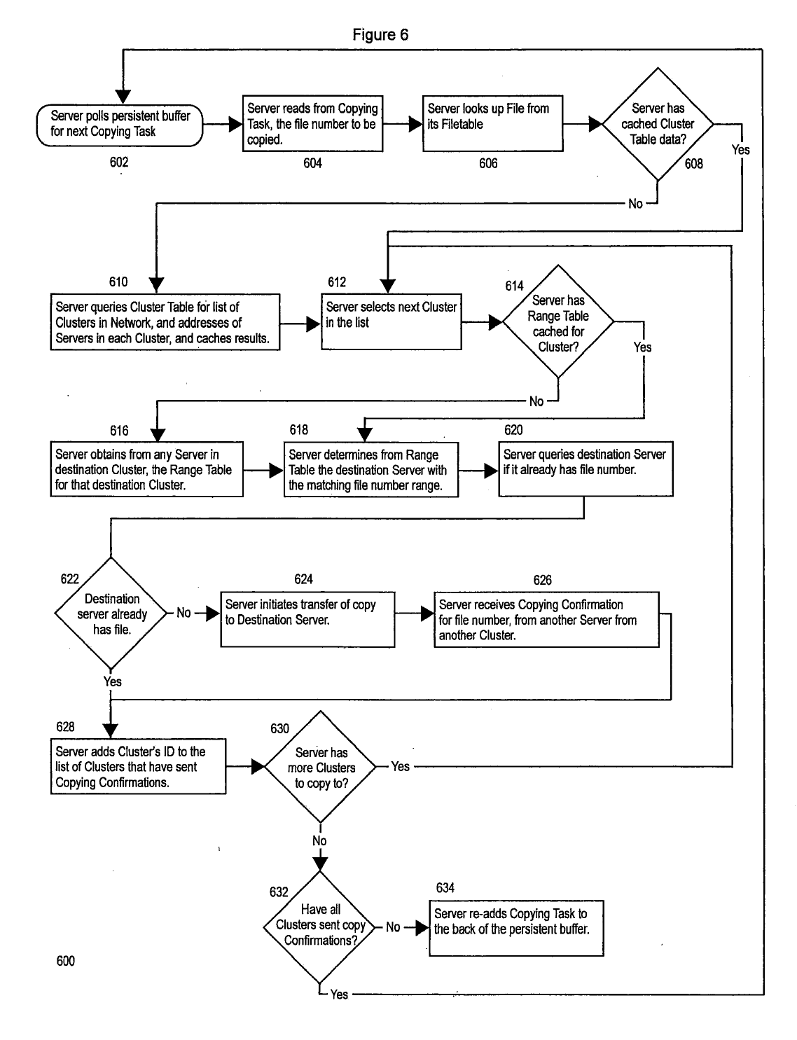

Referring to FIG. 6, further details regarding an algorithm for copying clusters provided in flowchart 600. This algorithm generally is initiated as a result of process 424 in FIG. 4b, where the copying task is placed in the persistence buffer. First at step 602, server 108 polls its data for the next copying task by pulling a copy of the copying task from the persistence buffer. Next at step 604, server 108 reads from the copying task the file number associated with the file to be copied. Next at step 606, server 108 looks up a file from its file table. Next at step 608, a test is made to determine whether server 108 has cached its cluster table data. If the cluster table data has not been cached then the process proceeds to step 610 where server 108 queries the cluster table for a list of clusters in the network and addresses of each server in the network and caches the results. After step 610, server 108 selects the next cluster in the list at step 612. If the data has been cached at step 608 then the process proceeds directly to step 612.

Next from 612, a process proceeds to step 614 where server 108 determines whether it has cached the range table for the cluster. If the range table has not been cached, the process proceeds to step 616 to obtain a range table. Following step 616, step 618 is performed where server 108 determines, from the range table, the destination server responsible for the file number range in which the file number falls. If the range table has been cached at step 614, then the process proceeds directly to step 618. After step 618, the process continues to step 620 where the server queries the destination server to determine whether the destination server already has the file number.

At step 622, a determination is made as to whether the destination server already has the file using previously described processes. If the destination server does not have the file then the process proceeds to steps 624 and 626, where server 108 initiates a transfer of the copy to the destination server and receives the copying confirmation message for the file number from another server and another cluster. Thereafter, the process proceeds to step 628 where server 108 adds the identification number of the cluster to the list of clusters that have sent the copying confirmations. If, however, from step 622 the destination server does have the file then the process proceeds to proceeds to 628. After steps 628, a further test is performed at steps 630 to determine whether there are more clusters that require updating with the file. If the determination is that there are more clusters, then the process proceeds back to step 612 to select the next cluster. If the determination is that there are no more clusters, then a further test is done at step 632 where a determination is made as to whether all clusters have sent the copy confirmations. If the determination is that all clusters have sent confirmations, then the process proceeds to start at step 602. If not all clusters have sent confirmations, then the process proceeds to step 634 where server 108 adds the copying test back to the persistent buffer and then the process returns to step 602. This completes an algorithm for the cluster backup process.

Now, further details are provided on other features of embodiments, related to processing of exceptions issues, including missing file number ranges, failed file copies, missing files and notification codes. Each is discussed in turn.

For missing file ranges, servers 108 may periodically communicate their file number ranges to one another at predefined intervals. Servers 108 can then analyze the received ranges to ascertain the health of the rest of the cluster. This is because in one configuration, a cluster should contain the file number range. If there is a gap in the data of ranges for the range table, this would indicate there are one or more unhealthy servers 108 or communication links.

In one configuration, the spare servers 108C in a cluster 110 monitor the file number ranges to detect gaps. If one or more of the spares detects a gap, then a spare is selected to raise an alert to an external monitoring system. The monitoring may be provided through periodic continuity checks performed by one or more of the servers 108 or by an external source. The alert may be provided in any form, such as an email notification to one or more interested parties. One embodiment preselects a spare server, such as the spare server 108 with the lowest server 108 identification number to raise the alert. In a multi-cluster system, that spare may then either by manual or automatic execution after a predefined auto-recovery delay, contact another cluster 110 in system 100 to initiate a mass copy of data for the missing file number ranges. If during that process, the spare server 108 reaches its predefined capacity limit, it may self-balance with another spare.

When a copy command for a file between clusters fails, client 104 sends a file to a server 108 that server 108 is responsible for initiating the copying process. As noted above, servers 108 may copy files to servers 108 in every other cluster. As any one of these copying steps may fail, a persistent buffering mechanism is used to ensure that each cluster successfully stores a copy.

After a server 108 stores a file, it queues a copying task marker for that file in the persistent buffer. The copying task is initially set to nil. As a server's copying task sends copies of files to servers 108 in other clusters, the server 108 updates the copying task's set of cluster identifications for clusters that have returned copying confirmations. The server 108 will repeat the copying task until every cluster in the system has returned a copying confirmation.

For missing files, each cluster 110 is responsible for ensuring every other cluster is not missing any units of data, by using the same mechanism for handling a failed copying, noted above. Each server 108 in a cluster, periodically queues copying tasks for each and every file that server 108 stores. The tasks may be queued in batches and may be executed on a low-priority basis. For each copying task, the server 108 contacts the servers 108 in other clusters, checking for copying confirmations. Clusters that already have the file will return a confirmation and any clusters missing the file will receive a copy of the file.

### Other Features

Now, further detail is provided on notification techniques and systems of an embodiment. In one embodiment, servers 108 have status codes which are set and shared to indicate to clients 104 whether or not they have successfully stored files. In a single cluster system, when client 104 sends a file to server 108 for storage and that server 108 fails to store the file, server 108 will return an error code to the client. Exemplary use of status codes was described earlier.

It will be appreciated that all algorithms, modules, processes, steps, sections, functions, calls and applications in the embodiments may be implemented using known programming techniques, languages and algorithms. The titles of the sections, processes and steps are provided as a convenience to provide labels and assign functions to certain features. It is not required that each module perform only its functions as described above. As such, specific functionalities for each application, algorithm, module, step, process, section, etc. may be moved between such items or separated into different items. Modules may be contained within other modules. Different signalling techniques may be used to communicate information between applications using known programming techniques. Known data storage, access and update algorithms allow data to be shared between applications. It will further be appreciated that other applications and systems in network 102 may be executing concurrently with any application in any server 108 or client 104. As such, one or more aspects of applications may be structured to operate as a “background” application on client 104, using programming techniques known in the art. Data may be stored in volatile and non-volatile devices described herein and updated by the hardware, firmware and/or software. Some of the processes may be distributed.

It will be appreciated that the described exemplary embodiments may be implemented in software, firmware and/or hardware applications, components, modules and fixtures known to those of skill in the art. Exemplary programming languages in which the source code for one or more of aspects of the embodiments are Java™, C++™, assembly language for a resident microprocessor and other languages known to those in the art. Any software or firmware instructions may be stored in one or more electronic storage devices (such as memory in the devices). Interrupt routines may be used. It will be appreciated that certain steps of processes described herein may be performed in different order(s) and in parallel streams than the steps described in the flow charts, being mindful of data consistency issues, per knowledge of a person of skill in the art.

As used herein, the wording “and/or” is intended to represent an inclusive—or, where “X and/or Y” is intended to mean X or Y or both.

In this disclosure, where a set of numbers is described, the set may be empty, contain one element or contain more than one element; where a threshold or measured value is provided as an approximate value (for example, when the threshold is qualified with the word “about”), a range of values will be understood to be valid for that value. For example, for a threshold stated as an approximate value, a range of about 20% larger and 20% smaller than the stated value may be used. Thresholds, values, measurements and dimensions of features are illustrative of embodiments and are not limiting unless noted.

The present invention is defined by the claims appended hereto, with the foregoing description being merely illustrative of embodiments of the invention. Those of ordinary skill may envisage certain modifications to the foregoing embodiments which, although not explicitly discussed herein, do not depart from the scope of the invention, as defined by the appended claims.

1. A method of processing an electronic file in a network of data storage servers, said method comprising:
upon receiving a request to store said file in said network generating a file number to be associated with said file from a set of file numbers;
associating said file number with said file;
for each server in said network, identifying a range of numbers in said set of file numbers that said each server is responsible for processing;
identifying a target server in said network associated with said file number; and
sending said file to said target server for storage by said target server in its memory.

2. The method of processing an electronic file in a network of data storage servers as claimed in claim 1, wherein the file number is meant to be a unique number for files in the network and is generated using a random number file generator.

3. The method of processing an electronic file in a network of data storage servers as claimed in claim 2, wherein said set of file numbers is at least 264 in size.

4. The method of processing an electronic file in a network of data storage servers as claimed in claim 2, wherein if said file number has already been assigned to another file, another file number for said file is generated from said set of file numbers.

5. The method of processing an electronic file in a network of data storage servers as claimed in claim 1, further comprising:
when a server in said network reaches a file capacity limit,
identifying a second server in said network;
copying files stored at said server to said second server;
dividing the range of number into a first range of numbers that said server tracks and a second range that said second server tracks;
deleting from said server files associated with said second range; and
deleting from said second server files associated with first range.

6. The method of processing an electronic file in a network of data storage servers as claimed in claim 1, further comprising:
maintaining for said server a configuration file that specifies the range of numbers in said set of file numbers assigned to said server.

7. The method of processing an electronic file in a network of data storage servers as claimed in claim 6, further comprising:
maintaining range table to track the range of numbers for all servers in a cluster associated with said server in said network.

8. The method of processing an electronic file in a network of data storage servers as claimed in claim 7, further comprising:
reconciling contents of said range table with data provided from other servers in said cluster associated with said server in said network.

9. The method of processing an electronic file in a network of data storage servers as claimed in claim 1, further comprising:
having said target storage server with a first cluster of servers in said network;
having a second set of said data storage servers in said network in a second cluster to also store files;
maintaining for said network a cluster file that tracks network locations of said first and second set of data storage servers; and
copying said file from said target storage server to a second server in said second set of data storage servers.

10. The method of processing an electronic file in a network of data storage servers as claimed in claim 9, further comprising:
associating a flag indicating a copy notification parameter with said file number and said file; and
generating a copy notification signal when said file is copied to a preset number of clusters.

11. The method of processing an electronic file in a network of data storage servers as claimed in claim 10, wherein:
said copy notification signal is generated when said file is copied to a server in another cluster.

12. The method of processing an electronic file in a network of data storage servers, said method further comprising:
upon receiving a request to retrieve a stored file from a client in said network
identifying an assigned file number associated with said stored file from said set of file numbers;
identifying said target server in said network associated with said assigned file number; and
initiating a request to said target server to retrieve and send said stored file to said client.

13. The method of processing an electronic file in a network of data storage servers as claimed in claim 9, wherein said request to store said file is generated from a client which is sent to said network.

14. A system of data storage servers for processing an electronic file, said system comprising:
a set of servers in a network for storing an electronic file comprising
a first server associated with a range of file numbers in a set of file numbers; and
a subset within said set of servers associated with a remaining range of file numbers in said set of file numbers;
a configuration file that contains data to specify the range of numbers in said set of file numbers assigned to said first server;
a range table file that contains data to track the range of numbers for all servers in said set of servers; and
a first application to process a request to store said file in said system, said first application processing said request by
identifying a server in said set that has a range of file numbers that contains a file number associated with said file; and
initiating storage of said file at said server in said set,
wherein the file number is meant to be a unique number for files in the network.

15. The system of data storage servers for processing an electronic file as claimed in claim 14, further comprising:
a second application to process a request to retrieve a stored file from a client in said network, said second application processing said request to retrieve said file by
identifying an assigned file number associated with said stored file from said set of file numbers;
identifying a target server in said network associated with said file number; and
initiating a request to said target server to retrieve said stored file.

16. The system of data storage servers for processing an electronic file as claimed in claim 15, further comprising a client application in communication with said network to initiate said request to retrieve said file and to receive said file from said network.

17. The system of data storage servers for processing an electronic file as claimed in claim 16, wherein said client application operates on a computer in communication with said network and said client application maintains a list of files that said client has processed through said network.

18. The system of data storage servers for processing an electronic file as claimed in claim 16, wherein said client application initiates a call to a third application to generate said file number for said request to store said file in said network.

19. The system of data storage servers for processing an electronic file as claimed in claim 14, further comprising:
a fourth application to balance an allocation of files when a server in said network reaches a file capacity limit, said third application initiating instructions to
copy files stored at said server to a second server;
divide the range of number into a first range of numbers that said server tracks and a second range that said second server tracks;
delete from said server files associated with said second range; and
delete from said second server files associated with first range.
